(19) United States
(12) Patent Application Publication
(10) Pub. No.: US 2013/0132438 A1
(43) Pub. Date: May 23, 2013

(54) Systems, methods, and computer program products for searching for space of interest (SOI)

(71) Applicants: Cheol-Woo Park, Seoul (KR); Hong-Hoi Kim, Daejeon (KR); Hyun Mi Kim, Uiwang (KR)

(72) Inventors: Cheol-Woo Park, Seoul (KR); Hong-Hoi Kim, Daejeon (KR); Hyun Mi Kim, Uiwang (KR)

(73) Assignee: Hyundai Motor Company, Seoul (KR)

(21) Appl. No.: 13/617,228

(22) Filed: Sep. 14, 2012

Related U.S. Application Data
(63) Continuation-in-part of application No. 13/320,649, filed on Nov. 15, 2011.
(60) Provisional application No. 61/591,212, filed on Jan. 26, 2012.

(30) Foreign Application Priority Data
May 15, 2009 (KR) 10-2009-0042401

(51) Int. Cl. G06F 17/30

(52) U.S. Cl. CPC G06F 17/30542
USPC 707/780

(57) ABSTRACT

One aspect of the invention provides a space of interest (SOI) search system including: an SOI dictionary unit configured to match a plurality of place-name identifiers (IDs) based on a geographical location to an SOI ID; and an SOI storage unit configured to store the matched SOI ID, place-name IDs, and related SOI information.

### CROSS-REFERENCE TO RELATED APPLICATIONS

This application claims priority under 35 U.S.C. §119(e) to U.S. Provisional Patent Application Ser. No. 61/591,212, filed Jan. 26, 2012. This application is also a continuation-in-part under 35 U.S.C. §120 of U.S. patent application Ser. No. 13/320,649, filed Nov. 15, 2011, which is a national phase application under 35 U.S.C. §371 of International Application No. PCT/KR2010/003055, filed May 14, 2010, which claim priority to Korean Patent Application No. 10-2009-0042401, filed May 15, 2009. The entire content of each of the above-referenced patent applications is hereby incorporated by reference herein.

### FIELD OF THE INVENTION

Embodiments of the present invention relate to an apparatus for storing a space of interest (SOI), and more particularly to a system for searching for an SOI in a database storing a variety of SOIs.

### BACKGROUND OF THE INVENTION

Generally, a point of interest (POI) location information is represented by X and Y coordinates. In more detail, when searching for a specific POI through a current Internet-based location information search service, X and Y coordinates (hereinafter referred to as XY coordinates) of the corresponding POI are displayed as a single point or dot on a predetermined-sized map.

In the case of managing data having been matched on the basis of X and Y coordinates, multiple location-based data pieces are matched to the same location, such that a plurality of coordinate information pieces can be generated or multiple data pieces indicating the same content can be represented at the same coordinates, resulting in the occurrence of unexpected confusion in the search result.

Referring to FIG. 1, if a user who uses a conventional system inputs a desired place, “K market”, as a keyword, not a more accurate place denoted by “K market,” but the entirety of a predetermined area including the corresponding place “K market” is recognized as the specific position “K market”. Due to the above-mentioned problem, the conventional location-based service is unable to provide the user with a more preferable search result having higher accuracy.

### BRIEF SUMMARY OF THE INVENTION

One aspect of the invention provides a space of interest (SOI) search system including: an SOI dictionary unit configured to match a plurality of place-name identifiers (IDs) based on a geographical location to an SOI ID; and an SOI storage unit configured to store the matched SOI ID, place-name IDs, and related SOI information.

In one embodiment, the SOI information includes coordinates of a center location of an SOI part, shape information of the SOI part, and coordinates of an outline of the SOI part.

In another embodiment, the SOI ID and the SOI information are managed by a user.

The system can include an SOI information generator configured to register or correct the SOI information.

The system can include an SOI search unit configured to (i) extract the SOI ID from the SOI dictionary unit on the basis of an externally-received term and (ii) receive the SOI information from the SOI storage unit on the basis of the extracted SOI ID.

The system can include a display unit for displaying the received SOI information.

Another aspect of the invention provides a method of searching for a space of interest (SOI). The method includes: receiving a search request specifying one or more search terms; conducting a search within a dictionary database using the search terms, the dictionary database containing aliases for a plurality of SOIs; obtaining information about one or more matching SOIs in the dictionary database; and returning the information about the one or more matching SOIs.

The method can include receiving a request to browse within one or more of the matching SOIs.

The method can include receiving a request to conduct a further search within one or more of the matching SOIs.

In another embodiment, the dictionary database contains a plurality of place-name IDs as the aliases, each of which is associated with an SOI ID.

In another embodiment, the dictionary database is associated with a particular user and the method further includes: removing unused aliases from the dictionary database of the particular user.

Another aspect of the invention provides a computer program product for causing a computer to perform a method of searching for a space of interest (SOI). The computer program product includes computer-usable medium having control logic stored therein that, when executed by a processor, is operable to: receive a search request specifying one or more search terms; conduct a search within a dictionary database using the search terms, the dictionary database containing aliases for a plurality of SOIs; obtain information about one or more matching SOIs in the dictionary database; and return the information about the one or more matching SOIs.

### BRIEF DESCRIPTION OF THE DRAWINGS

FIG. 1 is a conceptual diagram illustrating an exemplary method for providing a conventional location-based service.

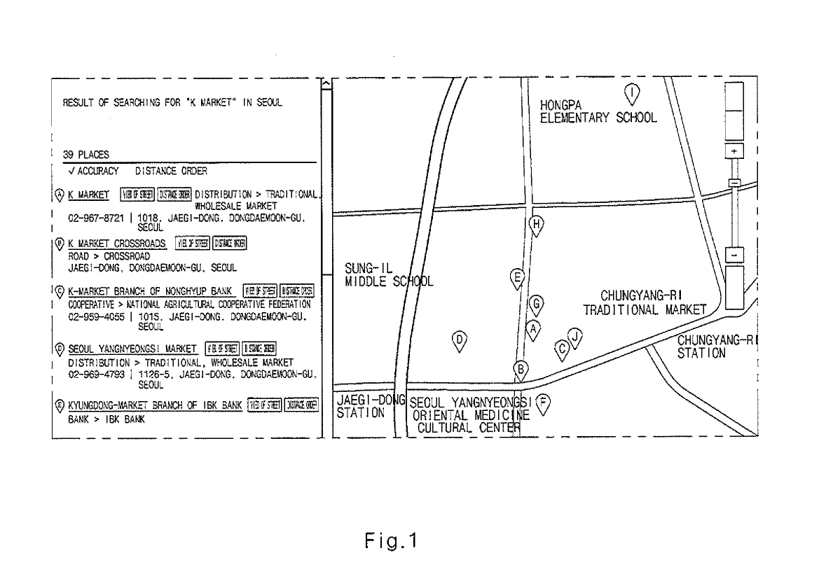

FIG. 2 is a conceptual diagram illustrating a method for providing an SOI search result according to one embodiment of the present invention.

FIG. 3 is a block diagram illustrating an SOI search system according to one embodiment of the present invention.

FIG. 4 is a conceptual diagram illustrating a method for extracting SOI information according to the matching result of a place-name ID and an SOI identifier (ID) according to one embodiment of the present invention.

FIG. 5 is a conceptual diagram illustrating a method for extracting SOI information depending upon a place-name ID and an SOI ID according to one embodiment of the present invention.

FIG. 6 is a block diagram illustrating an SOI search system according to one embodiment of the present invention.

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts. It is to be understood that the detailed description which will be disclosed along with the accompanying drawings is intended to describe the exemplary embodiments of the present invention and is not intended to describe a unique embodiment through which the present invention can be carried out. Hereinafter, the detailed description includes detailed matters to provide full understanding of the present invention. However, it will be apparent to those skilled in the art that the present invention can be carried out without such detailed matters. In some instances, well-known structures and devices are omitted in order to avoid obscuring the concepts of the present invention and the important functions of the structures and devices are shown in block diagram form.

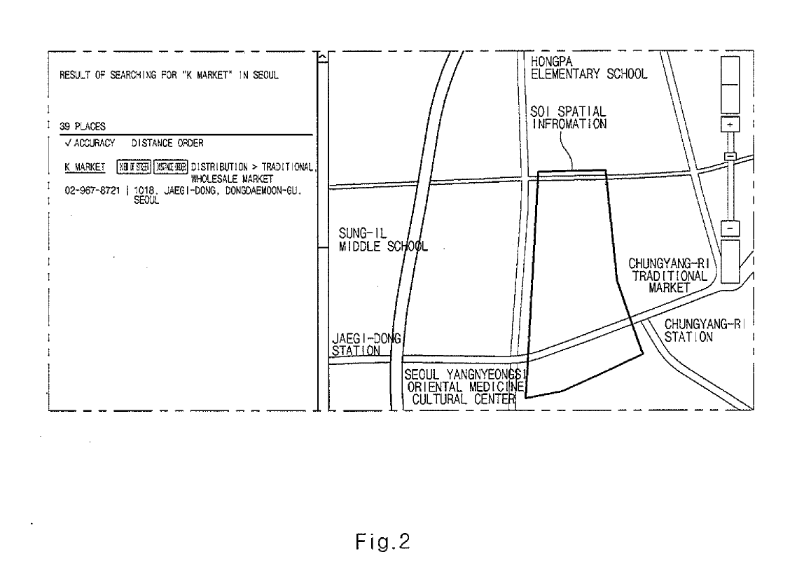

FIG. 2 is a conceptual diagram illustrating a method for providing a space of interest (SOI) search result according to one embodiment of the present invention.

Referring to FIG. 2, if a user inputs a keyword “K market” to search for a desired place, “K market”, the SOI provides two-dimensional (2D) spatial information instead of displaying a point indicating XY coordinates. In accordance with one embodiment of the present invention, the SOI information can include information of individual floors of a two-dimensional (2D) building. That is, the SOI information can include 3D spatial information including vertical relationship structure information therein.

The SOI information can display location information such as X and Y coordinates, relationship structure information including SOI relationship structure information, combining of SOI information, and information regarding a predetermined space located on a map. The SOI can further include shape information (for example, a point, a line, region information, building information, etc.) in the location information.

The SOI information can be stored in association with a predetermined SOI identifier (SOI ID). In accordance with one embodiment of the present invention, the SOI information can be stored in association with one or more SOI IDs. When searching for an SOI, the SOI ID is matched to the corresponding keyword, such that SOI information can be provided to the user.

If multiple pieces of information are input to a single coordinate, a plurality of pieces of point of interest (POI) information can be generated. If multiple pieces of information are input to an SOI indicating the same region, the input pieces of information can be managed as one piece of SOI information. In this case, one or more SOI IDs can be assigned to a single piece of SOI information.

In accordance with one embodiment of the present invention, although SOI information can include single information, the SOI information can be extended to a horizontal relationship structure or vertical relationship structure. The SOIs having a horizontal relationship structure can be linked to each other, or can be provided as the result of a single SOI.

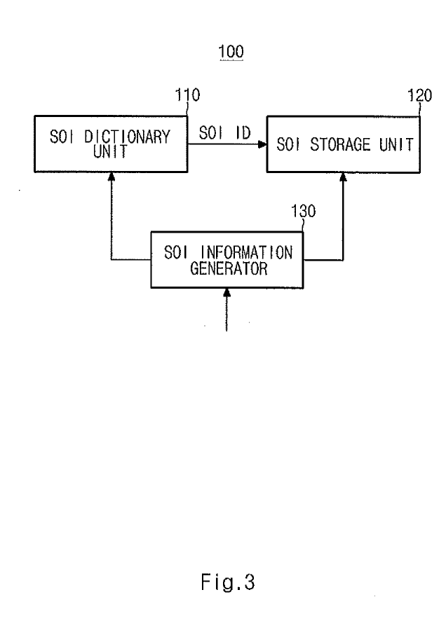

FIG. 3 is a block diagram illustrating an SOI search system according to one embodiment of the present invention.

Referring to FIG. 3, the SOI search system 100 can include an SOI dictionary unit 110, an SOI storage unit 120, and an SOI information generator 130.

The SOI dictionary unit 110 matches a place-name ID based on a geographical location to an SOI ID. For example, the place-name ID can be set to an address name decided by an address system. In another example, the place-name ID can be set to a geographical name contained in a general user idea, for example, “Kevin market”, “Matthew street”, “Walter road”, “Kenneth market”, etc. In addition, the SOI dictionary unit 110 can collect synonyms instead of such geographical names, store the collected synonyms as individual place-name IDs, and match an appropriate SOI ID to the stored place-name ID as necessary.

Therefore, the SOI search system 100 according to one embodiment of the present invention assigns not only a place name based on the address system but also a common notional place-name widely used by a general user to a place-name ID, and matches the SOI ID to the corresponding place-name ID, such that it can search for an SOI as if it were a dictionary.

The SOI storage unit 120 stores the SOI ID in association with SOI information. In accordance with one embodiment, one or more SOI IDs can also be associated with such SOI information. In addition, space IDs (i.e., SOI IDs) for hierarchically managing SOI information (for example, higher SOI ID, lower SOI ID, associated SOI ID, etc.) can be assigned to the SOI information.

For example, the SOI information can be assigned a single SOI ID. However, assuming that constant pieces of SOI information are horizontally associated with each other, the associated pieces of SOI information can be simultaneously searched for, such that associated SOI IDs are assigned to the associated pieces of SOI information to be identified from each other. In addition, since specific SOI information can be stored as lower SOI information of another piece of SOI information, a higher SOI ID and a lower SOI ID are assigned to the specific SOI information in such a manner that the SOI information can be managed by the higher and lower SOI IDs.

The SOI information generator 130 can register new SOI information. If SOI information is changed, the SOI information generator 130 stores the changed SOI information in the SOI storage unit 120. Registration or change of the SOI information can be achieved through external input, or the SOI information can be changed through internal correction of the SOI search system.

For example, an expert, a regional expert, etc. can change a region established by SOI information to another region, or can change current information to other information. The expert, the regional expert, etc. can provide the SOI information generator 130 with a variety of information, for example, information indicating that the designated SOI information region is different from an actual region, place-name IDs of commonly-accepted spaces of general users, etc. As a result, the SOI information generator 130 can correct or generate SOI information on the basis of the received information, or can store the corrected or generated SOI information in the SOI storage unit 120. In addition, a new place-name ID can be provided to the SOI dictionary unit 110.

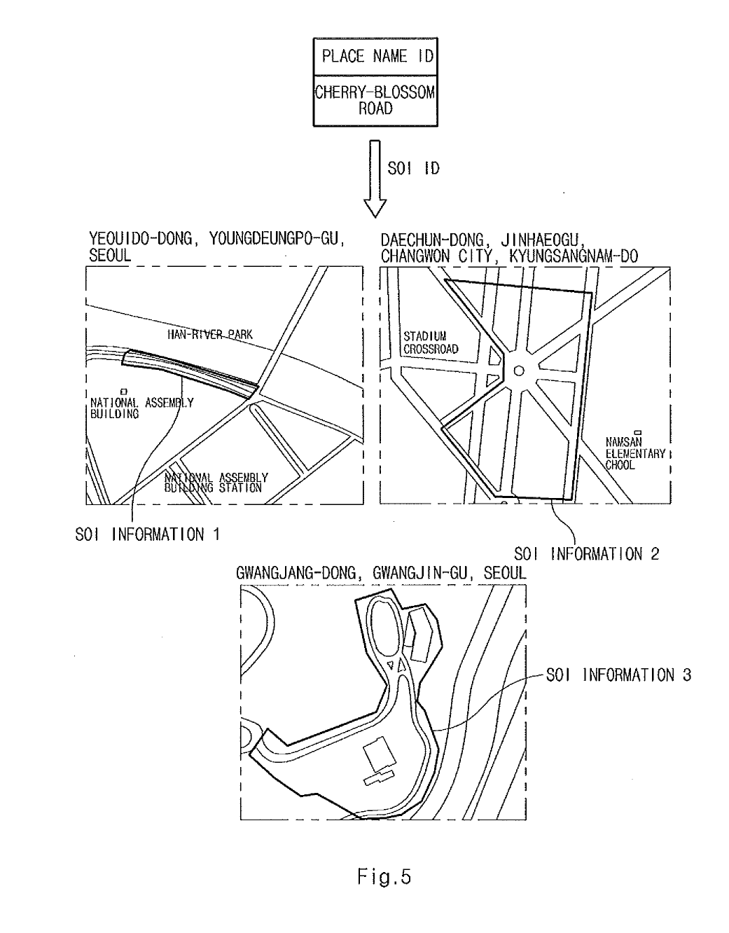

In addition, a plurality of SOI IDs can be matched to one place-name ID according to one embodiment of the present invention, and a detailed description thereof will hereinafter be described with reference to FIG. 5.

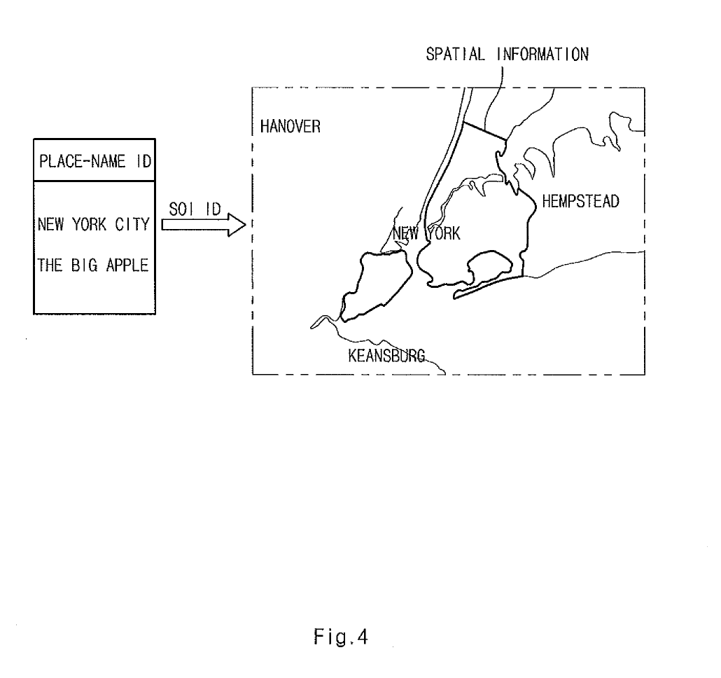

FIG. 4 is a conceptual diagram illustrating a method for extracting SOI information according to the matching result of a place-name ID and an SOI identifier (ID) according to one embodiment of the present invention.

Referring to FIG. 4, various place-name IDs (for example, “New York City” and “The Big Apple”) are matched to SOI information through the SOI ID. The place name “New York City” is a commonly-used place name recognized by the address system. However, the place name “New York City” is conceptually identical to a synonym “The Big Apple” not officially recognized by the address system, and corresponds to a geographical name commonly accepted by general users. Different place names, “New York City” and “The Big Apple”, can be managed by the SOI dictionary unit 110 and can be assigned the same SOI ID.

The SOI storage unit 120 stores an SOI ID and SOI information to be related to each other. Thus, if the SOI ID is provided through the SOI dictionary unit 110, the SOI storage unit 120 can provide the SOI information in response to the received SOI ID.

FIG. 5 is a conceptual diagram illustrating a method for extracting SOI information depending upon a place-name ID and an SOI ID according to one embodiment of the present invention.

Referring to FIG. 5, multiple pieces of SOI information correspond to a single place-name ID “Cherry-blossom road”. In accordance with one embodiment of the present invention, multiple SOI IDs are matched to the place name “Cherry-blossom road” of the SOI dictionary unit 110, such that multiple pieces of SOI information can be provided from the SOI storage unit 120 in response to the SOI ID.

The SOI dictionary unit 110 thus matches multiple place-name IDs to multiple SOI IDs, and stores the matched result. In addition, the SOI dictionary unit 110 provides ID information for each user such that it can provide different SOI dictionary units to individual users. If a place-name ID and an SOI ID are differently matched to each other by each user, the SOI dictionary unit 110 provides optimum SOI information to each user, and need not store a place-name ID not used by the corresponding user, such that the storage space is largely reduced and the entire operation speed of the search system is improved.

An SOI ID matched to a place name ID and associated SOI information thereof can have priority decided on the basis of the location of a current user. In accordance with one embodiment of the present invention, SOI information closest to the user location can have highest priority.

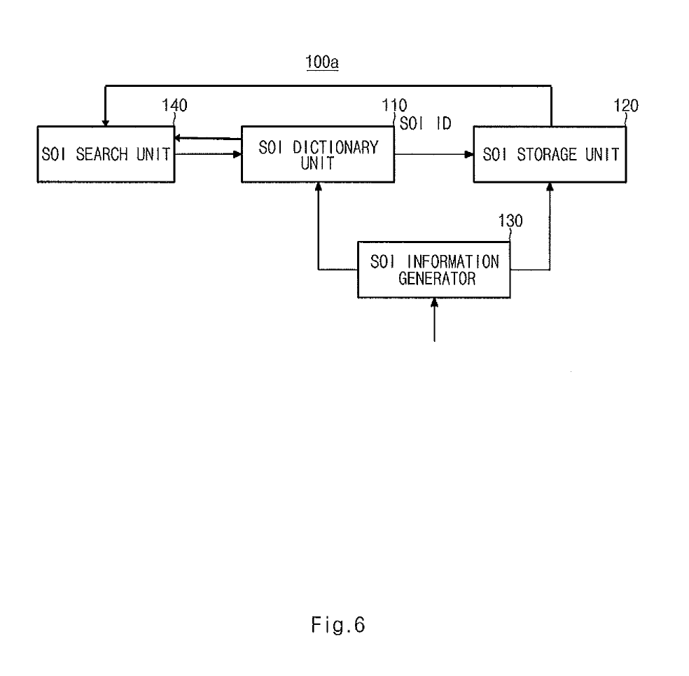

FIG. 6 is a block diagram illustrating an SOI search system according to one embodiment of the present invention.

Compared with the SOI search system 100 shown in FIG. 3, the SOI search system 100a shown in FIG. 6 can further include an SOI search unit 140. In the following description, the same reference numbers as in FIG. 3 will be used throughout the drawings to refer to the same or like parts, and thus a detailed description thereof will be omitted herein for convenience of description.

The SOI search unit 140 provides a keyword received from an external part to the SOI dictionary unit 110. In response to the input keyword, the SOI dictionary unit 110 can provide an SOI ID matched to a place-name ID to the SOI storage unit 120. The SOI storage unit 120 can transmit SOI information associated with an SOI ID to the SOI search unit 140.

In accordance with one embodiment of the present invention, the SOI search unit 140 changes a keyword corresponding to a place-name ID stored in the SOI dictionary unit 110, and provides the changed result to the SOI dictionary unit 110. In accordance with another embodiment of the present invention, the SOI dictionary unit 110 compares a place-name ID with a keyword on the basis of the keyword received from the SOI search unit 140, and extracts an SOI ID according to the comparison result.

The SOI search unit 140 can provide a user with SOI information on the basis of the received SOI information. Although not shown in FIG. 6, the SOI search system 100a can further include a display unit, such that it can provide a user with the searched SOI information through the display unit.

The display unit can be any of well-known elements, for example, a Liquid Crystal Display (LCD), a Light Emitting Diode (LED), etc. If necessary, the display unit can also be implemented as a touchscreen, etc.

The SOI search system according to one embodiment of the present invention matches various place-name IDs to an SOI ID, extracts associated SOI information according to the matched result, and provides the extracted result. Accordingly, the SOI search system can provide information regarding an optimum geographical region in response to a geographical name commonly accepted by general users, instead of providing the officially-decided address system, such that it can provide information regarding a user-desired geographical location. As a result, the SOI search system according to the present invention can provide an adaptive location-based service capable of satisfying a user request.

Those skilled in the art will appreciate that the present invention can be carried out in other specific ways than those set forth herein without departing from the spirit and essential characteristics of the present invention. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. Also, it is obvious to those skilled in the art that claims that are not explicitly cited in the appended claims can be presented in combination as an exemplary embodiment of the present invention or included as a new claim by a subsequent amendment after the application is filed.

As is apparent from the above description, the SOI search system according to one embodiment of the present invention supplements the conventional system that provides location-based data using a keyword database (DB) including a variety of keywords, such that the above-mentioned SOI search system can provide SOI information using a geographical identifier (ID) capable of substituting for a keyword, or can also provide SOI information by matching the keyword-based search result to the geographical ID. Therefore, the SOI search system according to one embodiment of the present invention can simplify the search process for providing location-based data, and at the same time can provide a user with a desired search result.

The SOI search system according to another embodiment of the present invention matches a plurality of geographical IDs to a plurality of SOI IDs, and provides the SOI information based on the matching result. As a result, the SOI search system minimizes a time needed for providing a variety of SOI information, and increases accuracy of location-based data provision.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A space of interest (SOI) search system comprising:
an SOI dictionary unit configured to match a plurality of place-name identifiers (IDs) based on a geographical location to an SOI ID; and
an SOI storage unit configured to store the matched SOI ID, place-name IDs, and related SOI information.

2. The SOI search system according to claim 1, wherein the SOI information includes coordinates of a center location of an SOI part, shape information of the SOI part, and coordinates of an outline of the SOI part.

3. The SOI search system according to claim 1, wherein the SOI ID and the SOI information are managed by a user.

4. The SOI search system according to claim 1, further comprising:
an SOI information generator configured to register or correct the SOI information.

5. The SOI search system according to claim 1, further comprising:
an SOI search unit configured to (i) extract the SOI ID from the SOI dictionary unit on the basis of an externally-received term and (ii) receive the SOI information from the SOI storage unit on the basis of the extracted SOI ID.

6. The SOI search system according to claim 5, further comprising:
a display unit for displaying the received SOI information.

7. A method of searching for a space of interest (SOI), the method comprising:
receiving a search request specifying one or more search terms;
conducting a search within a dictionary database using the search terms, the dictionary database containing aliases for a plurality of SOIs;
obtaining information about one or more matching SOIs in the dictionary database; and
returning the information about the one or more matching SOIs.

8. The method of claim 7, further comprising:
receiving a request to browse within one or more of the matching SOIs.

9. The method of claim 7, further comprising:
receiving a request to conduct a further search within one or more of the matching SOIs.

10. The method of claim 7, wherein the dictionary database contains a plurality of place-name IDs as the aliases, each of which is associated with an SOI ID.

11. The method of claim 7, wherein the dictionary database is associated with a particular user, the method further comprising:
removing unused aliases from the dictionary database of the particular user.

12. A computer program product for causing a computer to perform a method of searching for a space of interest (SOI), the computer program product comprising computer-usable medium having control logic stored therein that, when executed by a processor, is operable to:
receive a search request specifying one or more search terms;
conduct a search within a dictionary database using the search terms, the dictionary database containing aliases for a plurality of SOIs;
obtain information about one or more matching SOIs in the dictionary database; and
return the information about the one or more matching SOIs.
